(19) United States
(12) Patent Application Publication
(10) Pub. No.: US 2024/0142932 A1
(43) Pub. Date: May 2, 2024

(54) SCRIPT CREATION METHOD FOR ROBOT PROCESS AUTOMATION AND ELECTRONIC DEVICE USING THE SAME

(71) Applicant: UNITED MICROELECTRONICS CORP., Hsinchu (TW)

(72) Inventors: Yu-Chi LIN, Taichung City (TW); Li-Hsin YANG, Tainan City (TW)

(21) Appl. No.: 17/994,423

(22) Filed: Nov. 28, 2022

(30) Foreign Application Priority Data
Oct. 28, 2022 (TW) 111141110

(51) Int. Cl. G05B 19/042; G06V 20/40; G06V 30/10

(52) U.S. Cl. CPC G05B 19/0426; G06V 20/41; G06V 20/46; G06V 20/49; G06V 30/10; G05B 2219/24147

(57) ABSTRACT

A script creation method for robot process automation and an electronic device using the same are provided. The electronic device includes an area defining unit, a recording unit, an analysis unit and a creation unit. The area defining unit is configured to obtain a recording area of a screen. The recording unit is configured to record a video according to the recording area. The analysis unit is configured to analyze a plurality of actions according to the video. The creation unit is configured to build a plurality of steps of a script according to the actions.

This application claims the benefit of Taiwan application Serial No. 111141110, filed Oct. 28, 2022, the subject matter of which is incorporated herein by reference.

### BACKGROUND OF THE INVENTION

### Field of the Invention

The invention relates in general to a script creation method for robot process automation, and more particularly to a script creation method for robotic process automation (RPA) and an electronic device using the same.

### Description of the Related Art

During a semiconductor process, the operator needs to perform setting and a series of operations on a semiconductor machine. For different products or different manufacturing processes, the operator needs to frequently change the settings of the semiconductor machine. The operation procedure is complicated and time-consuming and affects process efficiency. Therefore, research personnel are devoted to the development of an automation system for controlling the manufacturing process to increase process efficiency.

### SUMMARY OF THE INVENTION

The invention is directed to a script creation method for robotic process automation (RPA) and an electronic device using the same. A recording unit records the operation process of the semiconductor machines or electronic devices as a video. Then, an analysis unit obtains various actions from the video through analysis, so that a creation unit can automatically create a script for robot process automation. Henceforth, the operations of the semiconductor machines or electronic devices can be automatically completed through the script executed by an execution unit.

According to one embodiment of the present invention, an electronic device is provided. The electronic device includes an area defining unit, a recording unit, an analysis unit and a creation unit. The area defining unit is configured to obtain a recording area of a screen. The recording unit is configured to record a video according to the recording area. The analysis unit is configured to analyze a plurality of actions according to the video. The creation unit is configured to build a plurality of steps of a script according to the actions.

According to another embodiment of the present invention, a script creation method for robotic process automation (RPA) is provided. The script creation method for robot process automation includes the following steps. A recording area of a screen is obtained. A video is recorded according to the recording area. A plurality of actions is analyzed according to the video. A plurality of steps of a script is built according to the actions.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of remote control of semiconductor machines according to an embodiment.

FIG. 2 is a schematic diagram of remote control of an electronic device according to an embodiment.

FIG. 3 is a block diagram of remote control of an electronic device according to an embodiment.

FIG. 4 is a flowchart of a script creation method for robot process automation according to an embodiment.

FIG. 5 is a detailed flowchart of step S130 according to an embodiment.

FIG. 6 is a detailed flowchart of S131.

FIG. 7 is a detailed flowchart of S132.

FIG. 8 is a detailed flowchart of S133.

FIG. 9 is a detailed flowchart of S134.

FIGS. 10 to 11 are schematic diagrams of the contents of segmentation nodes.

FIG. 12 is a detailed flowchart of S134.

FIG. 13 is a schematic diagram of the contents of text input action and click action.

### DETAILED DESCRIPTION OF THE INVENTION

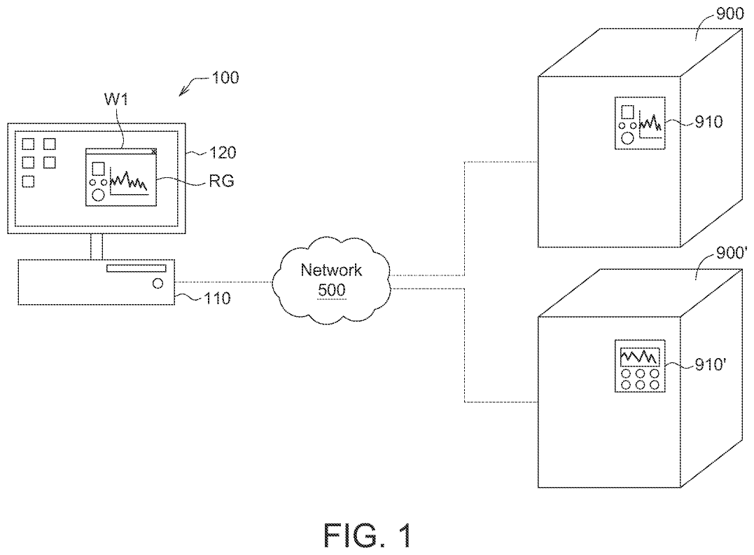

Referring to FIG. 1, a schematic diagram of remote control of semiconductor machines 900 and 900′, . . . according to an embodiment is shown. Each of the semiconductor machines 900 and 900′, . . . can be realized by a deposition machine, an exposure machine, an etching machine or an annealing machine. The semiconductor machines 900, 900′, . . . respectively include interfaces 910, 910′, . . . . The operator can directly set parameters on the interfaces 910, 910′, . . . and perform various operations to control the semiconductor machines 900, 900′, . . . to perform a semiconductor manufacturing process.

An electronic device 100 is connected to the semiconductor machines 900, 900′, . . . through a network 500. The electronic device 100 includes a host 110 and a screen 120. The screen 120 can display the interfaces 910 and 910′, . . . of the semiconductor machines 900, 900′, . . . on a remote control window W1. The operator can directly operate the interfaces 910 and 910′, . . . through the electronic device 100 to remotely control the semiconductor machines 900, 900′, . . . . In an embodiment, the electronic device 100 can be realized by a laptop computer, a desktop computer, or an all-in-one computer. The electronic device 100 can switch from the semiconductor machine 900 to another semiconductor machine 900′ to through a KVM switcher to control the semiconductor machine 900′.

In the present embodiment, the operation process displayed on the remote control window W1 of the screen 120 can be recorded as a video. Then, various actions can be obtained from the video through suitable analysis to automatically create a script of robotic process automation (RPA). Henceforth, the operations of the semiconductor machines 900, 900′, . . . can be automatically completed through the execution of the script.

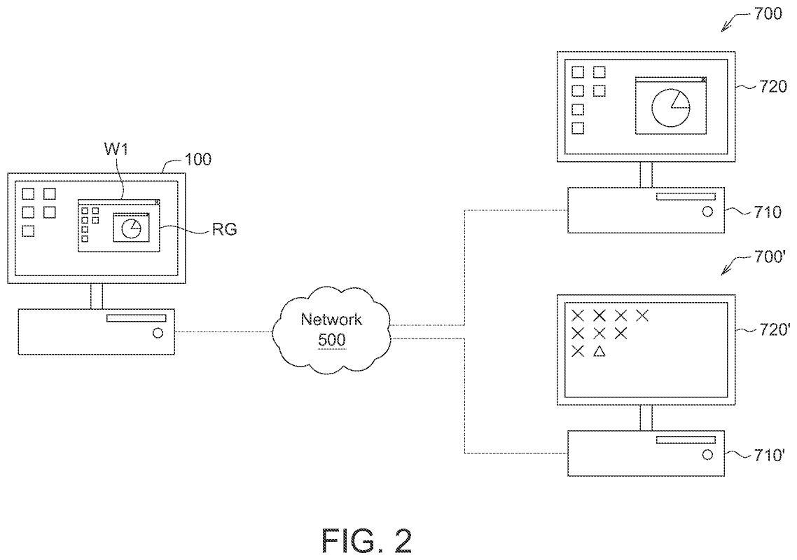

Referring to FIG. 2, a schematic diagram of remote control of the electronic devices 700, 700′, . . . according to an embodiment is shown. The electronic devices 700, 700′, . . . can be realized by such as a desktop computer, a notebook computer, a smartphone, or a server. The electronic devices 700, 700′, . . . respectively include hosts 710, 710′, . . . and screens 720, 720′, . . . .

The electronic device 100 is connected to the electronic devices 700, 700′, . . . through a network 500. The screen 120 can display the contents of the screen 720, 720′, . . . on a remote control window W1. The operator can remotely control the electronic devices 700, 700′, . . . through the electronic device 100. The electronic device 100 can switch from the electronic device 700 to another electronic device 700′ through a KVM switcher to control another electronic device 700′.

In the present embodiment, the operation process displayed on the remote control window W1 of the screen 120 can be recorded as a video. Then, various actions can be obtained from the video through suitable analysis to automatically create a script of robotic process automation. Henceforth, the operations of the electronic devices 700, 700′, . . . can be automatically completed through the execution of the script.

The semiconductor machines 900, 900′, . . . or the electronic devices 700, 700′, . . . can create an RPA script through the electronic device 100 without having to be installed with any additional software package. Detailed descriptions of the script creation method for robot process automation of the present embodiment are disclosed below.

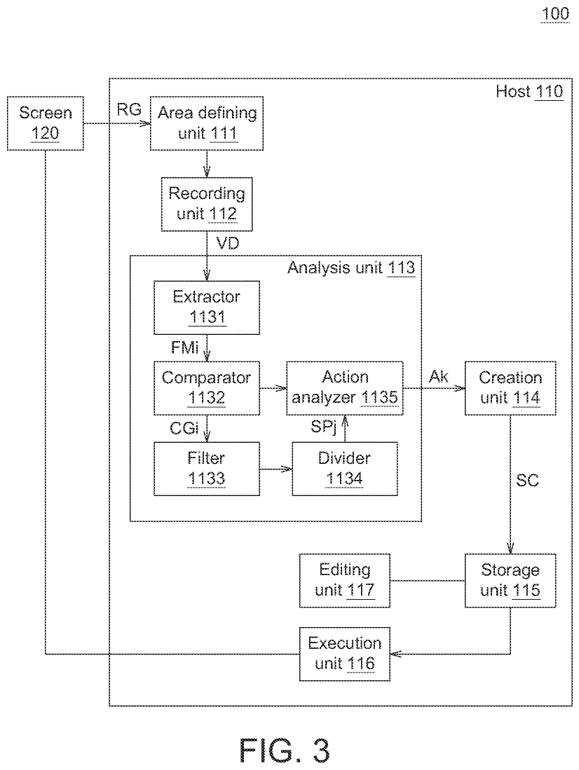

Referring to FIG. 3, a block diagram of an electronic device 100 according to an embodiment. The electronic device 100 includes host 110 and the screen 120. host 110 includes an area defining unit 111, a recording unit 112, an analysis unit 113, a creation unit 114, a storage unit 115, an execution unit 116 and an editing unit 117. The area defining unit 111, the recording unit 112, the analysis unit 113, the creation unit 114, the execution unit 116 and the editing unit 117 can be realized by such as a circuit, a chip, a circuit board, a code, a computer program product or a storage device for storing code. The storage unit 115 can be realized by such as a memory, a hard drive or a cloud storage.

In the present embodiment, the operation process of the semiconductor machines 900, 900′, . . . or the electronic devices 700, 700′, . . . can be recorded as a video VD by the electronic device 100 using the recording unit 112. Then, various actions Ak can be obtained from the video VD by the analysis unit 113 through the analysis, so that the creation unit 114 can automatically create a script SC for robotic process automation. Henceforth, the operations of the semiconductor machines 900, 900′, . . . or the electronic devices 700, 700′, . . . can be automatically completed through the script SC executed by the execution unit 116. Detailed operations of each element are disclosed below with a flowchart.

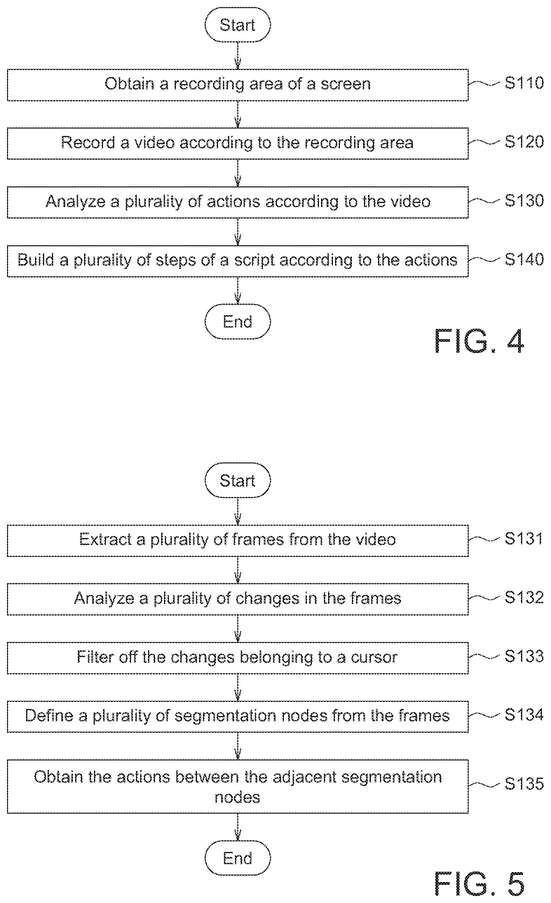

Referring to FIG. 4, a flowchart of a script creation method for robot process automation according to an embodiment is shown. In step S110, a recording area RG of the screen 120 is obtained by the area defining unit 111. Take FIG. 1 or FIG. 2 for instance. The recording area RG is such as the scope of the remote control window W1. The remote control window W1 displays the interfaces 910 and 910′, . . . of the semiconductor machines 900, 900′, . . . at a remote end or the frames of the electronic devices 700, 700′, . . . at a remote end. The recording area RG is a partial scope of the screen 120; the recording area RG is the entire scope of the interfaces 910 and 910′, . . . of the semiconductor machines 900, 900′, . . . at a remote end or the frames of the electronic devices 700, 700′, . . . at a remote end. The recording area RG can be defined by the user or can be the window on the topmost layer automatically identified by software or circuit.

Next, the method proceeds to step S120, a video VD is recorded by the recording unit 112 according to the recording area RG. During the process of recording the video VD, the recording area RG does not change, and all the contents, including text input, text deletion, cursor movement, menu popping out and menu closing, displayed on the recording area RG will be recorded. The recording unit 112 records only the video VD but not the audio contents or any input/output signals (such as mouse signal or keyboard signal).

Then, the method proceeds to step S130, a plurality of actions Ak are analyzed by the analysis unit 113 according to the video VD. In the present embodiment, the analysis unit 113 analyzes the actions Ak according to the contents of the video VD rather than the input/output signals (such as mouse signal or keyboard signal) received by the electronic device 100. As indicated in FIG. 3, the analysis unit 113 includes an extractor 1131, a comparator 1132, a filter 1133, a divider 1134 and an action analyzer 1135. The extractor 1131, the comparator 1132, the filter 1133, the divider 1134 and the action analyzer 1135 are configured to perform a series of analysis on the video VD.

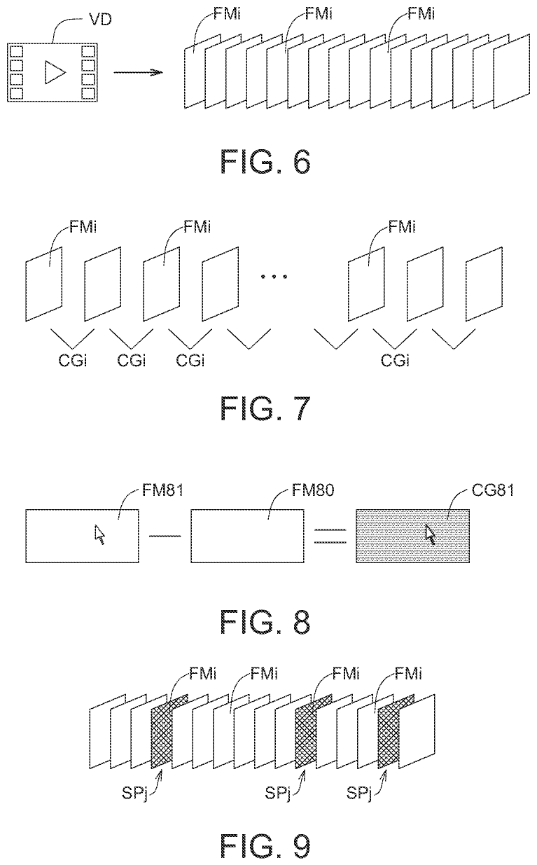

Referring to FIG. 5, a detailed flowchart of step S130 according to an embodiment is shown. Step S130 includes steps S131 to S135. In step S131, a plurality of frames FMi are extracted from the video VD by the extractor 1131. Referring to FIG. 6, a detailed flowchart of step S131 is shown. In step S131, each frame FMi is extracted from the video VD by the extractor 1131. Or, a part of frames FMi are extracted from the video VD by the extractor 1131 at a fixed interval of time.

Then, the method proceeds to step S132, a plurality of changes CGi in the frame FMi are analyzed by the comparator 1132. Referring to FIG. 7, a detailed flowchart of step S132 is shown. In step S132, each extracted frame FMi is compared with its previous frame FMi by the comparator 1132, and the difference between the two frames FMi is change CGi. The change CGi can be the addition/deletion of text or pattern, color change or brightness change.

Then, the method proceeds to step S133, the changes CGi belonging to a cursor are filtered off by the filter 1133. Referring to FIG. 8, a detailed flowchart of step S133 is shown. Take FIG. 8 for instance. If the cursor appears at a particular place of the frame FM81 but cannot be found at the corresponding place of the previous frame FM80, the change CG81 is identified as the pattern of the cursor. Since cursor movement normally does not trigger the execution of operation, the changes CGi belonging to the cursor are filtered off by the filter 1133 in the present embodiment, so that analysis accuracy can be increased.

Then, the method proceeds to step S134, a plurality of segmentation nodes SPj are defined in the frames FMi by the divider 1134. Referring to FIG. 9, a detailed flowchart of step S134 is shown. In step S134, whether each change CGi is greater than a predetermined degree (such as 10% of the frame) is determined by the divider 1134. If the change CGi is greater than the predetermined degree, the frame FMi is defined as a segmentation node SPj. As indicated in FIG. 9, 3 frames FMi among 16 frames FMi are defined as segmentation nodes SPj.

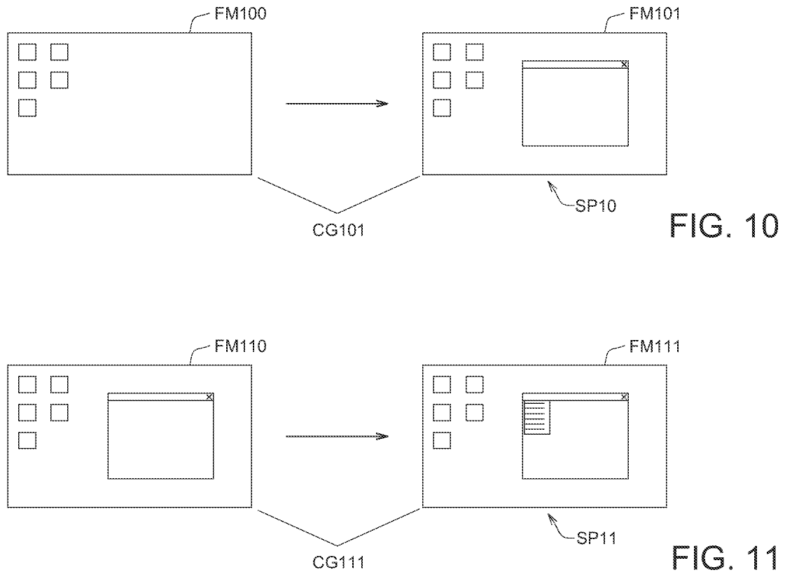

Referring to FIGS. 10 to 11, schematic diagrams of segmentation nodes SP10 and SP11 are shown. As indicated in FIG. 10, when a frame FM100 is changed to a frame FM101, a new window pops out. A change CG101 is greater than the predetermined degree, and the frame FM101 is defined as segmentation node SP10. As indicated in FIG. 11, when a frame FM110 is changed to a frame FM111, a new window pops out. A change CG111 is greater than the predetermined degree, and the frame FM111 is defined as segmentation node SP11.

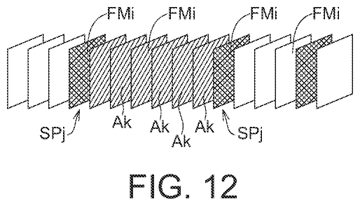

Then, the method proceeds to step S135, actions Ak between adjacent segmentation nodes SPj are obtained by the action analyzer 1135. Referring to FIG. 12, a detailed flowchart of step S134 is shown. As indicated in FIG. 12, there are frames FMi between adjacent segmentation nodes SPj. The action analyzer 1135 analyzes the frames FMi and obtains 4 actions Ak.

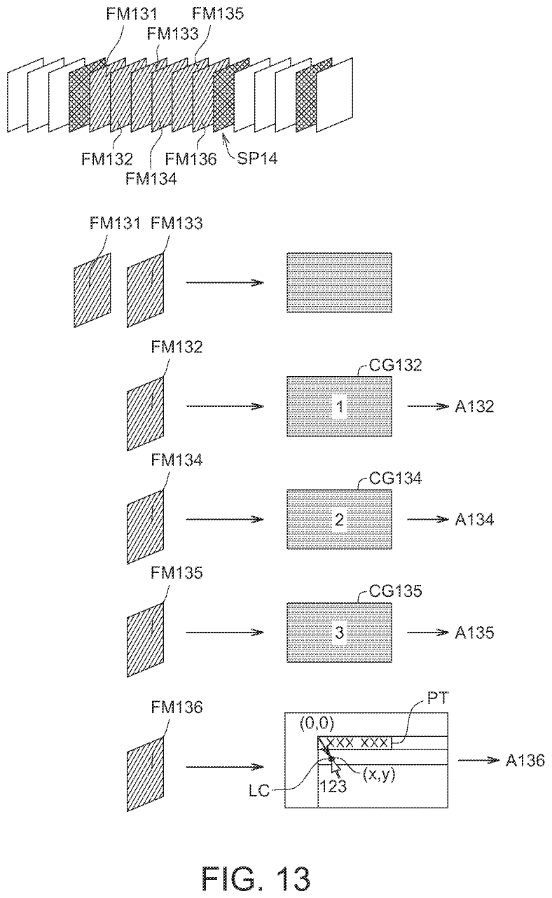

Referring to FIG. 13, a schematic diagram of the contents of text input actions A132, A134 and A135 and a click action A136 is shown. As indicated in FIG. 13, there are no changes in the frames F131 and FM133. The change CG132 in the frame FM132 is a newly added text “1”; the newly added text “1” is recorded to obtain the text input action A132 where “1” is inputted. The change CG134 in the frame FM134 is a newly added text “2”; the newly added text “2” is recorded to obtain the text input action A134 where “2” is inputted. The change CG135 in frame FM135 is a newly added text “3”; the newly added text “3” is recorded to obtain the text input action A135 where “1” is inputted. The newly added texts “1”, “2”, “3” can be obtained by using an optical character recognition (OCR) technology.

A frame FM136 is the frame before the segmentation node SP14. In the frame FM136, the reference pattern PT and a relative location LC of the cursor relative to the reference pattern PT are recorded to obtain a click action A136 where the screen or the mouse is clicked. The reference pattern PT and the relative location LC are configured to define the execution position of the click action A136.

Apart from text input actions or click actions, a newly added rectangular frame of each change CGi between adjacent segmentation nodes SPj can also be recorded to obtain a circle action.

Apart from text input actions or click actions, a newly added highlighted area of each change CGi between adjacent segmentation nodes SPj can also be recorded to obtain a text highlight action.

One or several actions Ak can be obtained through steps S131 to S135.

In step S140 of FIG. 4, a plurality of steps of script SC are built by the creation unit 114 according to the actions Ak. As indicated in FIG. 3, the script SC is stored in the storage unit 115. Then, the execution unit 116 can obtain the script SC to automatically execute the actions Ak. During the execution process, the actions Ak of the script SC are also executed on a remote control window W1 in a remote control manner.

In an embodiment, a mixed-type script creation method can be used. That is, the editing unit 117 obtains the script SC and further edits it to complete detailed settings.

As disclosed in the above embodiments, the electronic device 100 can record the operation process of the semiconductor machines 900, 900′, . . . or the electronic devices 700, 700′, . . . as the video VD using the recording unit 112. Then, various actions Ak can be obtained from the video VD by the analysis unit 113 through analysis, so that the creation unit 114 can automatically create a script SC for robot process automation. Henceforth, the operations of the semiconductor machines 900, 900′, . . . or the electronic devices 700, 700′, . . . can be automatically completed through the script SC executed by the execution unit 116.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An electronic device, comprising:
an area defining unit, configured to obtain a recording area of a screen;
a recording unit, configured to record a video according to the recording area;
an analysis unit, configured to analyze a plurality of actions according to the video; and
a creation unit, configured to build a plurality of steps of a script according to the actions.

2. The electronic device according to claim 1, wherein the analysis unit comprises:
an extractor, configured to extract a plurality of frames from the video;
a comparator, configured to analyze a plurality of changes in the frames;
a filter, configured to filter off the changes belonging to a cursor;
a divider, configured to define a plurality of segmentation nodes from the frames, wherein the changes in each of the segmentation nodes are greater than a predetermined degree; and
an action analyzer, configured to obtain the actions between the segmentation nodes, which are adjacent.

3. The electronic device according to claim 2, wherein the action analyzer records a newly added text in the changes between the segmentation nodes, which are adjacent, to obtain a text input action.

4. The electronic device according to claim 3, wherein the action analyzer obtains the newly added text by using an optical character recognition (OCR) technology.

5. The electronic device according to claim 2, wherein the action analyzer records a reference pattern and a relative location of the cursor relative to the reference pattern at each of the segmentation nodes to obtain a click action.

6. The electronic device according to claim 2, wherein the action analyzer records a newly added rectangular frame in each of the changes between the segmentation nodes, which are adjacent, to obtain a circle action.

7. The electronic device according to claim 2, wherein the action analyzer records a newly added highlighted area in each of the changes between the segmentation nodes, which are adjacent, to obtain a text highlight action.

8. The electronic device according to claim 1, wherein the recording area is a scope of a remote control window.

9. The electronic device according to claim 8, wherein the remote control window displays an interface of a semiconductor machine located at a remote end, the recording area is a partial scope of the screen, and the recording area is an entire scope of the interface of the semiconductor machine.

10. The electronic device according to claim 8, wherein the actions of the script are configured to be executed on the remote control window.

11. A script creation method for robotic process automation (RPA), comprising:
obtaining a recording area of a screen;
recording a video according to the recording area;
analyzing a plurality of actions according to the video; and
building a plurality of steps of a script according to the actions.

12. The script creation method for robot process automation according to claim 11, wherein the step of analyzing the actions according to the video comprises:
extracting a plurality of frames from the video;
analyzing a plurality of changes in the frames;
filtering off the changes belonging to a cursor;
defining a plurality of segmentation nodes from the frames, wherein the changes in each of the segmentation nodes are greater than a predetermined degree; and
obtaining the actions between the segmentation nodes, which are adjacent.

13. The script creation method for robot process automation according to claim 12, wherein a newly added text in the changes between the segmentation nodes, which are adjacent, is recorded to obtain a text input action.

14. The script creation method for robot process automation according to claim 13, wherein the newly added text is obtained by using an optical character recognition (OCR) technology.

15. The script creation method for robot process automation according to claim 12, wherein a reference pattern and a relative location of the cursor relative to the reference pattern at each of the segmentation nodes are recorded to obtain a click action.

16. The script creation method for robot process automation according to claim 12, wherein a newly added rectangular frame in each of the changes between the segmentation nodes, which are adjacent, is recorded to obtain a circle action.

17. The script creation method for robot process automation according to claim 12, wherein a newly added highlighted area in each of the changes between the segmentation nodes, which are adjacent, is recorded to obtain a text highlight action.

18. The script creation method for robot process automation according to claim 11, wherein the recording area is a scope of a remote control window.

19. The script creation method for robot process automation according to claim 18, wherein the remote control window displays an interface of a semiconductor machine located at a remote end, the recording area is a partial scope of the screen, and the recording area is an entire scope of the interface of the semiconductor machine.

20. The script creation method for robot process automation according to claim 18, wherein the actions of the script are configured to be executed on the remote control window.
